(19) United States
(12) Patent Application Publication
(10) Pub. No.: US 2017/0147755 A1
(43) Pub. Date: May 25, 2017

(54) CLOUD BASED PERSONAL HEALTH RECORD MANAGEMENT METHOD AND DEVICE

(71) Applicant: Electronics and Telecommunications Research Institute, Daejeon (KR)

(72) Inventors: Myung-eun LIM, Daejeon (KR); Jae Hun CHOI, Daejeon (KR); Minho KIM, Daejeon (KR); YoungWon KIM, Daejeon (KR); Ho-Youl JUNG, Daejeon (KR); Youngwoong HAN, Daejeon (KR); Dae Hee KIM, Daejeon (KR); Seunghwan KIM, Daejeon (KR)

(21) Appl. No.: 15/360,913

(22) Filed: Nov. 23, 2016

(30) Foreign Application Priority Data
Nov. 24, 2015 (KR) 10-2015-0165040

(51) Int. Cl. G06F 19/00; G06F 17/30; H04L 29/06

(52) U.S. Cl. CPC G06F 19/322; H04L 63/08; G06F 17/30106; G06F 17/30011

(57) ABSTRACT

Provided are a personal cloud based personal health record management method and device for allowing users to dominantly manage personal health records, which are accumulated and managed by each of various health service institutions, through a personal health record management device and a personal cloud repository.

### CROSS-REFERENCE TO RELATED APPLICATIONS

This U.S. non-provisional patent application claims priority under 35 U.S.C. §119 of Korean Patent Application No. 10-2015-0165040, filed on Nov. 24, 2015, the entire contents of which are hereby incorporated by reference.

### BACKGROUND

The present disclosure herein relates to a method and device for managing cloud based personal health records, and more particularly, to a method and device for managing personal cloud repository based personal health records, which store user's personal health records provided from a plurality of health record providers in a user's personal cloud repository by various types or each item and also search for the stored personal health records by a corresponding type or each item.

Due to the recent drastic development of medical technology and a low birth rate issue, society becomes aging gradually and symptoms of diseases due to changes in lifestyle and wrong eating habits occur slowly for a long period of time. Therefore, a prevalence of chronic diseases leading to disability becomes increased often.

Accordingly, a variety of health services including treatment service change to chronic disease prevention and continuous management based services based on user's personal health records accumulated for treating a user's disease.

Accordingly, in order to prevent and continuously manage chronic diseases and other various diseases, systematic health management based on user's recent accumulated personal health records is important and for this, it is necessary to integrally store and manage the user's personal health records.

However, existing personal health records are accumulated and managed mainly by medical institutions such as hospitals, oriental medical clinics, or health checkup centers, which provide the health services.

This causes an issue that the user's personal health records are not integrally provided as one and are distributed to several medial institutions providing the health services and also managed and operated non-systematically.

Additionally, since a service form provided from medical institutions providing the health services is mainly a closed form (that is, a service form specifically for a specific subject providing services), exchange, sharing or common use are not provided for each medical institution. Therefore, interoperability lacks and an optimal health service is not continuously provided for each user based on recent personal health records.

In order to integrally manage and maintain the user's personal health records, it is necessary to obtain a technique for receiving and integrally managing the user's personal health records from various medical institutions providing the health services. But such a technology does not exist now.

Accordingly, the inventive concept provides a method and device for managing personal health records to offer each optimal health service fit for users by storing personal health records, which are distributed to and managed by each medial institution providing the health services, in a personal cloud repository used by a personal user in order to integrally manage the personal health records based on the personal user and also by always updating the continuously accumulated personal health records according to various activities such as user's medical or health treatments in order to maintain recent personal health records.

Next, a simple explanation for the prior art pertaining to the technical field of the inventive concept will be made and then, different technical details of the inventive concept from the prior art will be described.

First, Korea Patent Publication No. 2011-0138896 (2011 Dec. 28) relates to a health information management service system and method, which allow an individual or an agreed medical team to view and update personal health record information and family health record information by managing each individual health record information and each individual's family related information through a server that manages health information.

The prior art and the inventive concept have some similarities in managing each individual health record information but the inventive concept does not describe or suggest technical features in receiving user's personal health records from a plurality of health record providers to store them in a personal cloud repository individually, updating existing personal health records to the latest, performing a fast search and view on the personal health records by using metadata, and managing user's personal health records dominantly by a user.

Additionally, Korea Patent Registration No. 0910405(2009 Jul. 27) relates to a method for integrating and managing customer health checkup information in linkage with an efficient customer response and customer management available EMR system as a health checkup center separated from a hospital accesses EMR and MIS of the hospital.

The prior art just manages the health checkup information integrally as each hospital links to the health checkup center, but cannot manage/maintain the health checkup information independently by a user, and manages the health checkup information based on a health institution. Therefore, the user cannot receive an optimized health service based on the health checkup information.

Additionally, Korea Patent Publication No. 2012-0124298 relates to a personal health record management system and method, which include a personal health record storage server for storing personal health records and a medical institution server for managing electronic treatment records, generating personal health records from the electronic treatment records to transmit them to toe personal health record storage server, and not changing the electronic treatment records by the access of the personal health record storage server.

The prior art relates to a method for storing personal health records in a personal smart terminal or PC and managing them as a personal client based management method. Therefore, when there is an issue in a client storage device, the entire data may be lost and health data is located at a specific position, so that it is difficult to deal with a utilization request for health service.

On the other hand, in addition to the health checkup information, the inventive concept stores personal health records, which are accumulated and managed by a plurality of medical institutions providing health records, in a storage operated by a personal user, so that a user may play an important role to maintain and manage the personal health records and keep the personal health records in the latest status always. As a result, an optimized personalized service for each user may be provided. Additionally, in relation to a cloud repository based health data management method, health data may be utilized at any place where cloud service access is possible and also may be protected safely according to a security rule of a cloud service provider.

### SUMMARY

The present disclosure provides a personal health record management method and device for efficiently maintaining and managing personal health records through a user as a subject by storing the personal health records, which are accumulated and managed in various formats by each of a plurality of medical institutions, in a user's personal repository.

An embodiment of the inventive concept provides a personal cloud based personal health record management device including: a metadata generation unit configured to receive a personal health record from at least one health record provider to generate metadata; and a storage management unit configured store the received personal health record and the metadata in a personal cloud repository.

In an embodiment, the device may further include a verification unit configured to verify the received personal health record, wherein the personal cloud based personal health record management device may generate metadata from the verified personal health record and store the metadata in the personal cloud repository.

In an embodiment, the device may further include: a verification unit configured to verify a personal health record provided from the at least one health record provider; and a user authentication unit configured to perform a user's authentication on the personal health record management device and a user's authentication on the personal cloud repository.

In an embodiment, the storage management unit may view account information on a user's personal cloud repository, update and store metadata on a corresponding account, and add and store a corresponding personal health record.

In an embodiment, the update may be performed by reading file metadata and record metadata on the user's account, adding only new document information to the file metadata if both an item of the file metadata and a newly inputted item are duplicate, and adding only information on a new item to the record metadata if only a part is duplicate.

In an embodiment, the update may be performed by reading file metadata and record metadata on the user's account and adding and storing the file metadata and the record metadata as a new document or a new item if a document ID is different.

In an embodiment, the device may further include a search management unit configured to search for and provide a personal health record by referring to metadata stored in the personal cloud repository according to a search condition inputted by a user.

In an embodiment, the search may be performed as combining a search result according to a corresponding search condition by, if the search condition inputted by the user is a document search, viewing file metadata to determine at least one document file to be provided and by, if the search condition inputted by the user is a record search, viewing record metadata to determine at least one record file to be provided.

In an embodiment, the search management unit may provide the found result to a user terminal after verifying a validity on each personal health record schema including treatment, checkup, or lifelog with respect to the found personal health record.

In an embodiment of the inventive concept, a personal cloud based personal health record management method includes: receiving a personal health record from at least one health record provider to generate metadata on the personal health record; and storing the received personal health record and the metadata in a personal cloud repository.

In an embodiment, the method may further include verifying the received personal health record, wherein the method may generate metadata from the verified personal health record and store the metadata in the personal cloud repository.

In an embodiment, the method may further include performing a user's authentication on a personal health record management device and a user's authentication on the personal cloud repository.

In an embodiment, the storing of the received personal health record and the metadata may include: viewing account information on a user's personal cloud repository; updating and storing metadata on a corresponding account; and adding and storing a corresponding personal health record.

In an embodiment, the updating and storing of the metadata on the corresponding account may include: reading file metadata and record metadata on the user's account; adding only new document information to the file metadata if both an item of the file metadata and a newly inputted item are duplicate; and adding only information on a new item to the record metadata if only a part is duplicate.

In an embodiment, the updating and storing of the metadata on the corresponding account may include: reading file metadata and record metadata on the user's account; and adding and storing the file metadata and the record metadata as a new document or a new item if a document ID is different.

In an embodiment, the method may further include searching for and providing a personal health record by referring to metadata stored in the personal cloud repository according to a search condition inputted by a user.

In an embodiment, the searching for the personal health record may be performed as combining a search result according to a corresponding search condition by, if the search condition inputted by the user is a document search, viewing file metadata to determine at least one document file to be provided and by, if the search condition inputted by the user is a record search, viewing record metadata to determine at least one record file to be provided.

In an embodiment, the searching for the personal health record may include providing the found result to a user terminal after verifying a validity on each personal health record schema including treatment, checkup, or lifelog with respect to the found personal health record.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a conceptual diagram illustrating a cloud based personal health record management method and device according to an embodiment of the inventive concept;

FIG. 2 is a block diagram illustrating a configuration of a personal health record management device according to an embodiment of the inventive concept;

FIG. 3 is a block diagram illustrating a configuration of a personal cloud repository according to an embodiment of the inventive concept;

FIG. 4 is a flowchart illustrating a procedure for managing personal health records by a user through a personal cloud repository according to an embodiment of the inventive concept;

FIG. 5 is a flowchart illustrating a procedure for storing personal health records in a personal cloud repository according to an embodiment of the inventive concept;

FIG. 6 is a flowchart illustrating a procedure for searching for personal health records from a personal cloud repository according to an embodiment of the inventive concept;

FIG. 7 is an exemplary view illustrating a configuration of metadata for a search of personal health records according to an embodiment of the inventive concept;

FIG. 8 is a view illustrating a CCR record item according to an embodiment of the inventive concept; and

FIG. 9 is a view illustrating a lifelog record item according to an embodiment of the inventive concept.

### DETAILED DESCRIPTION

Hereinafter, preferred embodiments of the inventive concept will be described in detail with reference to the accompanying drawings. Like reference numerals in each drawing denote like elements.

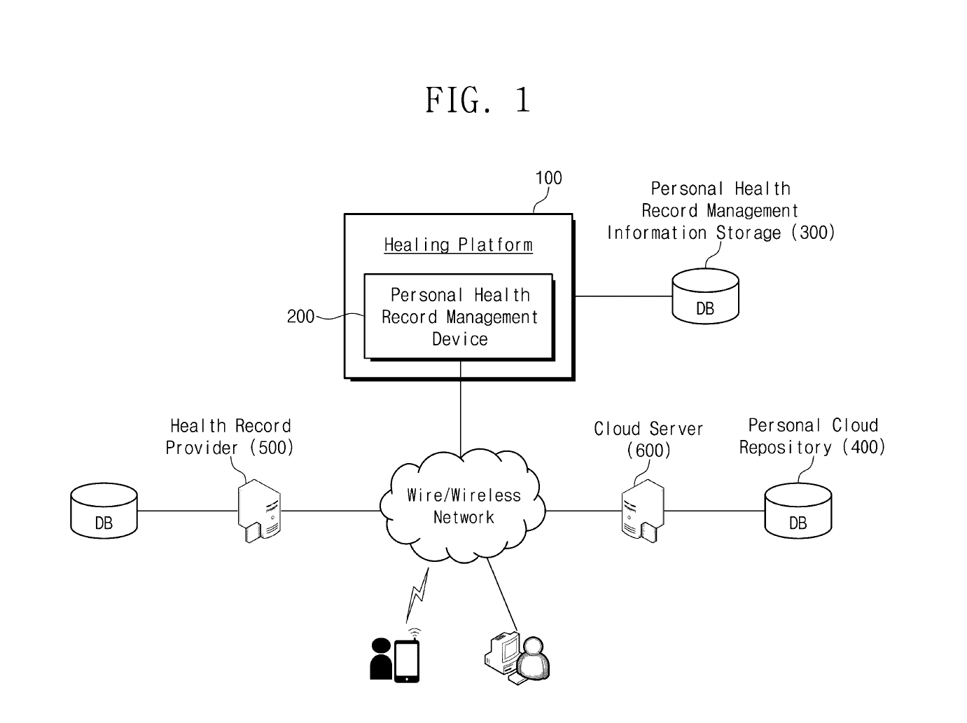

FIG. 1 is a conceptual diagram illustrating a cloud based personal health record management method and device according to an embodiment of the inventive concept.

First, in relation to existing technologies for personal health record management, as a form of receiving user's personal health records and storing them in a user's terminal after a user is authenticated by accessing a medical institution providing health records, a system is configured based on the medical institution instead of the user, which is the management subject for personal health records.

In relation to such a management system, since the personal health records are distributed over databases that a plurality of medical institutions own, it is difficult to manage the personal health records integrally and furthermore, since interoperability lacks due to an independent data format for each medical institution, it is difficult for a user to continuously receive reliable health service based on the user's personal health records.

Accordingly, provided are a personal health record management method and device for receiving and managing various formats of personal health records such as electronic health records of hospitals, health records of oriental medical clinics, fitness data, or lifelogs, managing the personal health records through a user, that is, a leading subject, to perform the exchange of the personal health records naturally, and providing a health service specified for each user based on the user's health records.

A personal cloud repository is a concept that is not limited to a small-sized private cloud established and operated privately and includes a repository that subscribes to and uses a large-sized private or public cloud service (for example, Dropbox, Google Drive, etc.). Furthermore, it is a reasonable concept to include all storage spaces that a user subscribes, receives, and uses privately.

As shown in FIG. 1, a personal health record management device 200, as one component of a healing platform 100, serves as a framework to relay the transmission/reception of user's personal health records between a user terminal, a health record provider 500, and a personal cloud repository 400.

Additionally, the user may install an application, provided from the healing platform 100, to a user's own terminal and then, request and receive the user's personal health records from the health record provider 500 through the installed application after performing a user authentication.

Moreover, the health record provider 500 may exist in various forms such as hospitals, oriental medical clinics, health checkup centers, or fitness centers, and provide corresponding user's personal health records to the user terminal through the user's authentication process.

Additionally, the user may provide personal health records provided from the health record provider 500 to the personal health record management device 200 to store them in the personal cloud repository 400 that the user manages.

Moreover, the user may activate the account of the personal cloud repository 400 through the cloud server 600 and perform an authentication on the personal cloud repository 400 by receiving a user ID, a password, and information of a corresponding personal repository for the personal cloud repository 400 issued by the cloud server 600.

Additionally, when receiving the user's personal health records, the personal health record management device 200 stores the personal health records in the corresponding user's personal cloud repository 400 after performing a user's authentication on the personal health record management device 200 and the personal cloud repository 400.

Moreover, the personal health records refer to various formats of personal health records including treatment data (for example, CCR) of hospitals, health checkup data of health checkup centers, lifelog data, or a combination thereof as time series data obtained by accumulating and recording user's health status, body information, user information, treatment status, or lifestyles.

Additionally, the personal health record management device 200 may store the personal health records as a single document file of an original unit in the personal cloud repository 400, separate a plurality of records constituting the stored document file into files of a record unit, and mapping them to a corresponding document file and store it.

Furthermore, the records refer to unit items representing user's body information, lifestyle information, or numerical information such as blood pressure, blood sugar, height, weight, the number of steps, or smoking status.

Additionally, when the personal health records are stored as a single document file of an original unit, duplicate records may exist in each document file.

For example, in the case of treatment data of hospitals, the treatment data includes a plurality of accumulated records such as blood pressure or blood sugar and there are duplicate records in 2004 among treatment data from 2002 to 2004 and treatment data from 2004 to 2006.

Additionally, if the treatment data is divided into files of the record unit and stored, a default storage unit is a unit item of a record.

This is, since the treatment data of the hospital is uniquely divided by each unit item and stored, the duplication occurring when the personal health records are stored as a single document file of an original unit does not occur.

Additionally, storing the single document file may be useful when a user searches for a specific personal health record of a complete original format, and separating into the files of the record unit and storing them may be useful when a user searches for records for a period specific item without duplicate records.

Additionally, the healing platform 100 is an integrated health solution for managing personal health records dominantly by a user by storing the personal health records distributed over and managed by each medical institution in the personal cloud repository 400 subscribed by the user through the personal health record management device 200, providing a prediction result on a personal future health status by searching for a case similar to a user's health status based on the stored personal health records, and based on this, providing various customized health services to the user.

Additionally, in order to manage the personal health records dominantly, a user may activate the account of the personal cloud repository 400 through the cloud server 600, and the healing platform 100 may allow the user to register and manage the user account healing platform 100 and the user account of the personal cloud repository 400.

Additionally, when there is a request for storing personal health records or a request for searching for a necessary portion in pre-stored personal health records from the user, the personal health record management device 200 requests a user ID and an access key for a corresponding personal cloud repository account and information on a personal cloud account from the user by referring to a user account registered to the healing platform 100 to map a corresponding user's ID and a personal cloud repository account and access key and store them in a personal health record management information storage 300.

Additionally, the personal health record management device 200 accesses the personal cloud repository 400 of a corresponding user by using the stored mapping information and through this, performs the storage or search that the user requests.

Additionally, the user may maintain the latest personal health records at all times by updating personal health records pre-stored in the personal cloud repository 400 with newly-added personal health records according to various activities such as user's treatments or health checkups through the personal health record management device 200.

Unlike the prior art that the personal health records are accumulated and managed by each health service institution, since a user provides the latest personal health records to the health service institution at all times, more accurate and reliable health promotion service may be provided.

Additionally, the personal health record management device 200 may store the personal health records separately in the personal cloud repository 400, and allow a separate search, and generate metadata for the search of the personal health records to store it in the personal cloud repository 400.

The metadata serves as an index for searching for and viewing the personal health records, and the personal health record management device 200 reads only the metadata to determine a range of the personal health records to be searched.

Moreover, in order to receive a reliable health service, a user may comprehensively and accurately search for health information such as accumulated changes of period specific status information, biometric information, and lifestyles of a user, from a large amount of time series personal health records and provide a corresponding search result to a health service institution. Of course, a medical institution performing the health service may perform the search request of the personal health records after taking over an authority from a user.

It takes a considerable search time for searching for period specific health information that a user wants from personal health records having the characteristics of a large amount of time series personal health records.

To solve this issue, the inventive concept extracts metadata according to user's important health information by each item from the large amount of time series personal health records and maps the personal health records to corresponding metadata to perform a simple and fast search process by using only the metadata instead of searching for the entire personal health records.

Additionally, the personal health record management device 200 may convert the personal health records into the same data format that all health service institutions are able to receive and then store them, and also convert the search result into a data format that all health service institutions want and then provide them.

Moreover, the same format may be XML or JSON format, which is the data standards expanding based on ASTM-CCR and HL7-CCD, that is, the international standards, and may be data standards defined by another method. According to the inventive concept, a method of defining the same data format to allow all medical institutions to receive the personal health records integrally is not limited.

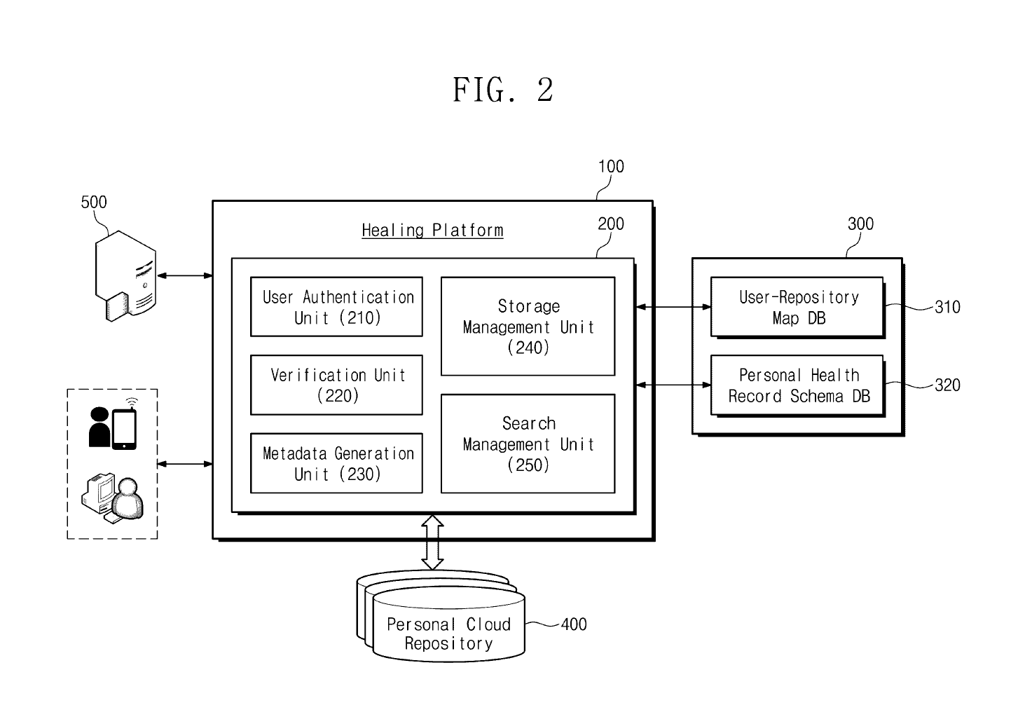

FIG. 2 is a block diagram illustrating a configuration of a personal health record management device according to an embodiment of the inventive concept.

As shown in FIG. 2, a personal health record management device 200 for dominantly managing user's personal health records by a user in linkage with a healing platform 100 is configured including a user authentication unit 210 for authenticating a user, a verification unit 220 for verifying user's personal health records, a metadata generation unit 230 for generating metadata of the verified personal health records, a storage management unit 240 for storing the personal health records in a personal cloud repository 400, and a search management unit 250 for searching for personal health records stored in the personal cloud repository 400.

Additionally, the personal health record management device 200 includes a personal health record management information storage 300 including a user-repository map DB 310 for storing an access key necessary for receiving a user's account and an access authority for the personal cloud repository 400 for a plurality of users and a personal health record schema DB 320 for storing various schemas of personal health records to verify their schemas.

Moreover, the user-repository map DB 310 and the personal health record schema DB 320 may be separately provided or provided in one storage.

Additionally, the user authentication unit 210 performs a user authentication on the personal health record management device 100 and the personal cloud repository 400.

The user authentication on the personal health record management device 100 may perform an authentication process through a user's ID and password issued from the healing platform 100.

Additionally, the user authentication on the personal cloud repository 400 is performed as the personal health record management device 200 requests an authentication with a user's ID and password with respect to the personal cloud repository 400 from the user by using the user-repository map DB 310, and receives an access key for this.

Additionally, the verification unit 220 may verify whether user's personal health records from a user are valid by referring the personal health record schema DB 320.

Moreover, the personal health record schema DB 320 may store various schemas of personal health records including a schema for treatment data of hospitals, a schema for lifelogs, and a schema for health checkup data of health checkup centers and then use them later.

Additionally, the metadata generation unit 230 may generate metadata for the search of the personal health records stored in the personal cloud repository 400, and store the generated metadata in the personal cloud repository 400.

Additionally, the metadata serves as an index for searching for and viewing the personal health records and is configured with file metadata for file index and record metadata for item index.

Additionally, an item refers to a unit item of a record, and for example, refers to user's measured individual health information such as blood pressure, blood sugar, height, and weight.

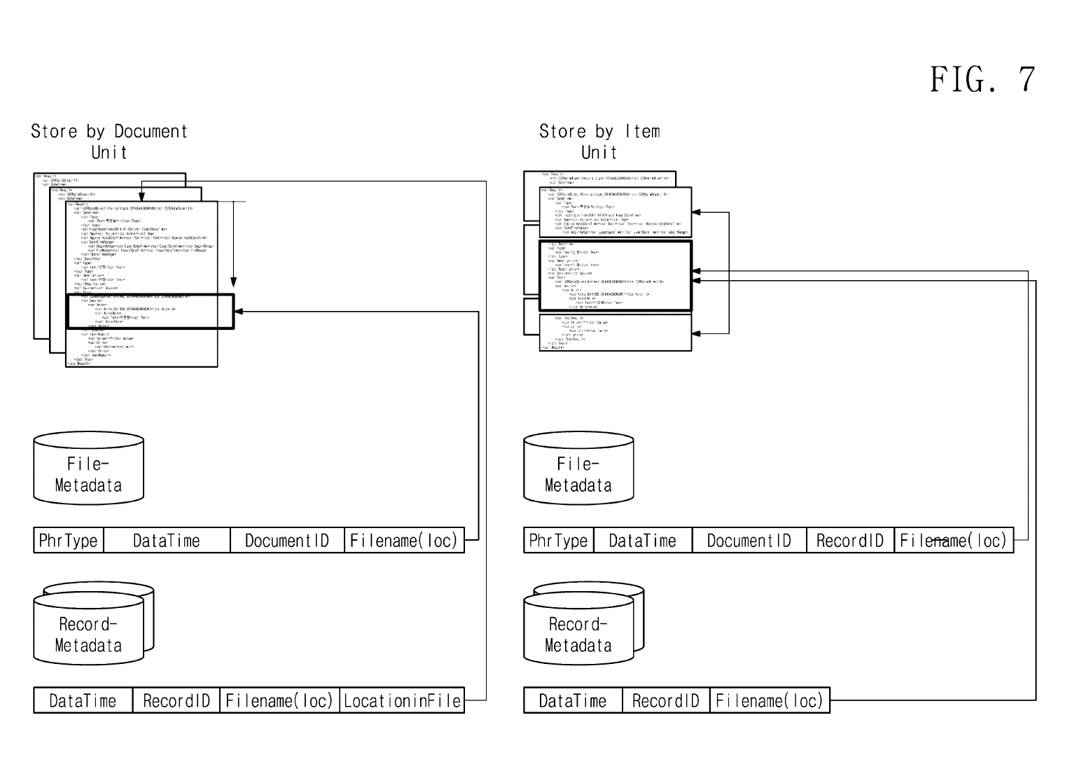

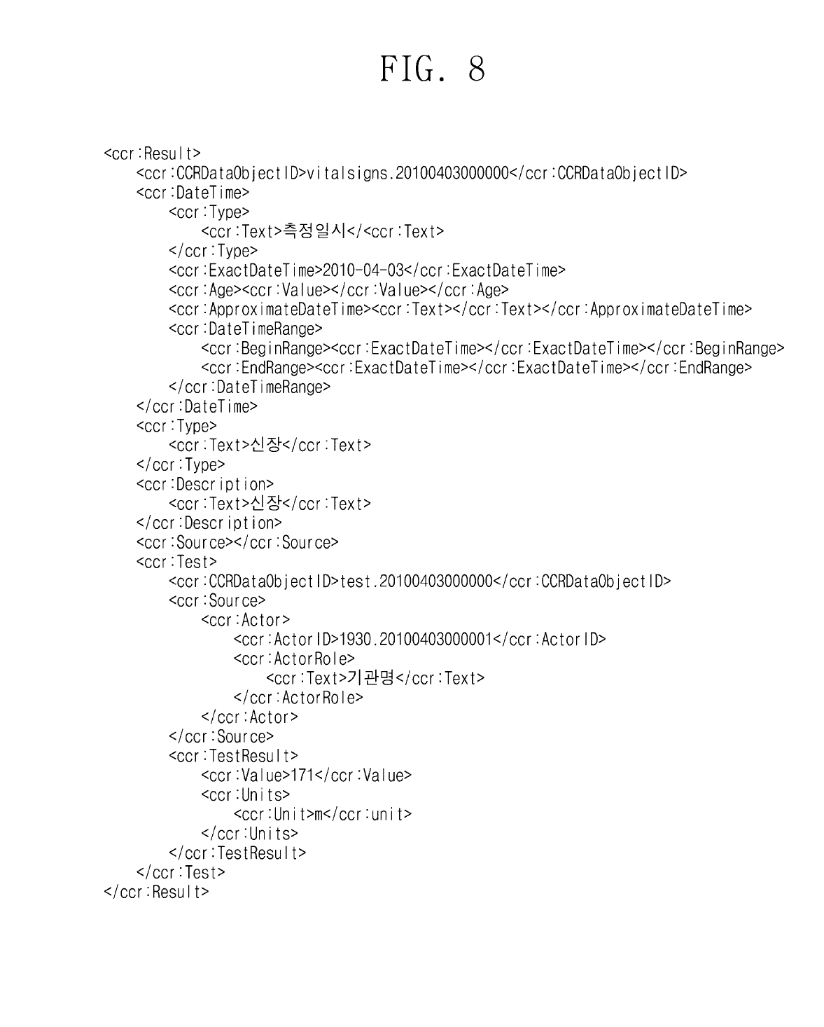

Moreover, a structure of the metadata will be described in detail with reference to FIGS. 7 and 8.

Additionally, the storage management unit 240 stores various types of personal health records provided from the user as a single document file of an original unit.

Additionally, the original refers to a document consisting of sets of each type of records and the document file may additionally store a type of a personal health record original, a measurement time, and a document ID for identifying an original document.

Additionally, the storage management unit 240 divides the original of the personal health record by a record unit and store it.

At this point a default storage unit may be stored as a unit item of a record; the original may be divided into a plurality of record files and stored; and an ID for identifying each record file may be additionally stored.

When treatment data (for example, CCR) is exemplarily described, documents may be uniquely identified by using CCRDocumentObjectID in the original CCR document of the personal health records as a document ID, and records may be uniquely identified by using CCRDataObjectID in the CCR document as a record ID. Additionally, if the personal health record original has no additional identifier like a lifelog, it assigns a document ID by a combination of a personal health record type (at this point, a personal health record type is a lifelog), a measurement time, and a record name, and assigns a record ID by a combination of a measurement item (for example, blood pressure, blood sugar, etc.) in a document to be identified and stored.

Additionally, in order to store the user's personal health records verified by the verification unit 220 in the personal cloud repository 400, the storage management unit 240 views account information on the personal cloud repository 400 of a corresponding user by referring to the user-repository map DB 310.

Additionally, if there are account information and an access key based on the view results, the storage management unit 240 makes an access by performing a user authentication on the personal cloud repository 400 of a corresponding user by using the information of the user-repository map DB 310. The user authentication is mentioned above and its detailed description will be omitted.

Additionally, when the storage management unit 250 requests metadata for user's personal health records from the accessed personal cloud repository 400, the personal cloud repository 400 may access file metadata and record metadata from the metadata DB 410 and transmit them to the storage management unit 240.

Additionally, as the storage management unit 240 reads the received file metadata, if both an item of the personal health record and an item of the file metadata are redundant, the storage management unit 240 adds only information of a new personal health record to file metadata to update the file metadata, and if only a portion of the item is redundant or the items are not redundant, adds new record information to the received record metadata to update the record metadata.

Additionally, the storage management unit 240 transmits the updated metadata and personal health record to the personal cloud repository 400 and the personal cloud repository 400 stores the received metadata and personal health record.

Additionally, if there is a search request for the user's personal health records from a user or a health service institution, as it is performed by the storage management unit 240, the search management unit 250 views account information for the personal cloud repository 400 of a corresponding user, performs a user authentication on the personal cloud repository 400 of the corresponding user to access the personal cloud repository 400 of the corresponding user, and receive metadata.

Additionally, if the search is a search of a document unit for personal health records, the search management unit 250 views the received file metadata to determine an original document file of personal health records to be provided to the user, and if the search is a search of a record unit, views the record metadata to determine a record file and requests the determined file from the personal cloud repository 400.

Additionally, if there is the request, the personal cloud repository 400 accesses the personal health record DB 420 to transmit at least one corresponding document file or at least one corresponding record file according to the determination.

Additionally, the search management unit 250 combines the plurality of received document files or record files to verify the validation of the combined file through the verification unit 200 and then, provides the verified data to the user or a health promotion service institution.

Moreover, the personal health record management device 200 converts the combined personal health record file into a data format that the user or the health service institution wants and provide it after verification.

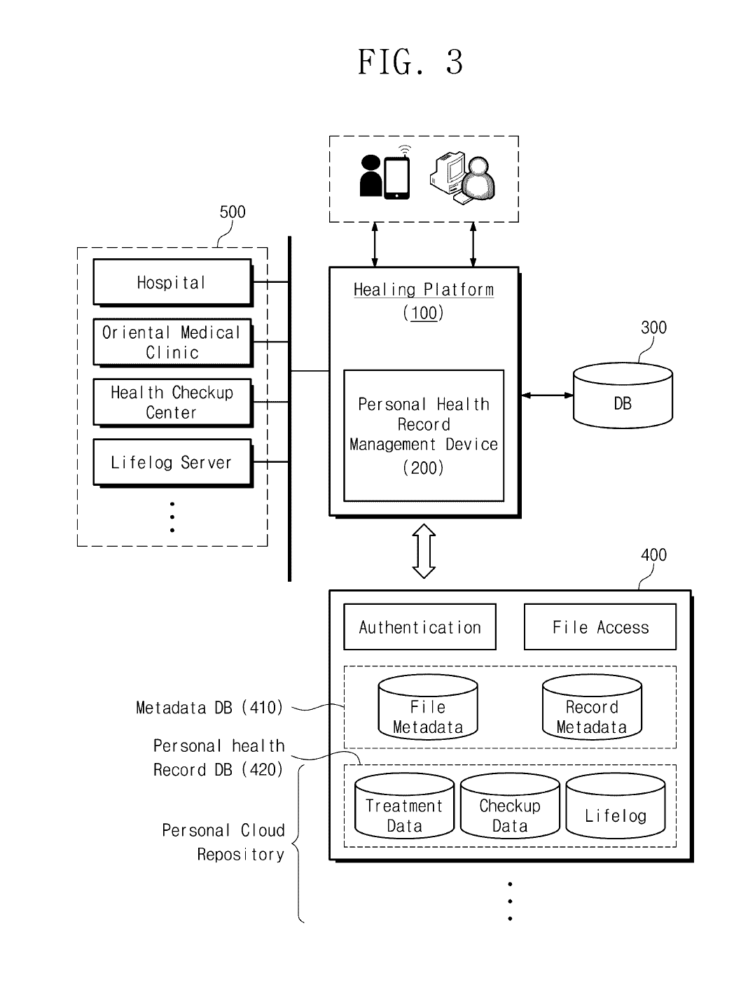

FIG. 3 is a block diagram illustrating a configuration of a personal cloud repository according to an embodiment of the inventive concept.

As shown in FIG. 3, the personal cloud repository 400 is configured including a metadata DB 410 for storing metadata for user's personal health records and a personal health record DB 420 for storing the user's personal health records by each type.

Additionally, the metadata DB 410 may be configured including a file metadata DB for storing file metadata for searching for or viewing the personal health records by each document unit and a record metadata DB for searching for and viewing the personal health records by each record, and a DB for storing the file metadata and a DB for storing the record metadata may not be stored separately and stored in one DB.

Additionally, the personal health record DB 420 may be configured including a plurality of DBs for storing the personal health records by each type (for example, treatment data, checkup data, or lifelog) and include a DB (not shown) for converting the personal health records stored by each type into a common data format that all medical institutions are able to receive and storing them.

Furthermore, although FIG. 3 illustrates treatment data, checkup data, and lifelog as one example, various types of personal health records may be further included.

Additionally, when there is a search or storage request from the personal health record management device 200, the personal cloud repository 400 performs a user authentication by using user information including user's ID and password for the corresponding personal cloud repository 400 and an access key, which are transmitted from the personal health record management device 200, to perform the search or storage process.

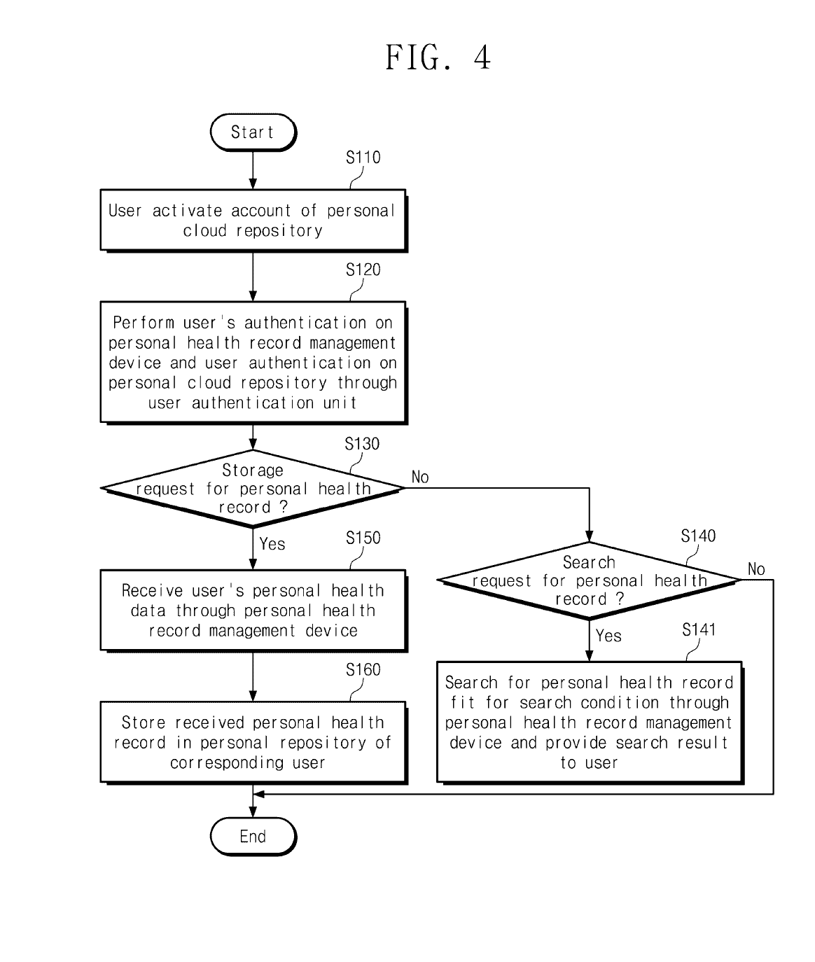

FIG. 4 is a flowchart illustrating a procedure for managing personal health records by a user through a personal cloud repository according to an embodiment of the inventive concept.

As shown in FIG. 4, first, a user activates the account of the personal cloud repository 400 for storing personal health records to dominantly manage his/her own personal health records in operation S110 and then, registers account information of a corresponding user to the user-repository map DB 310 through the healing platform 100 and manages it.

Moreover, the user-repository map DB 310 stores and manages a list for a user's account and user's information for the personal cloud repository 400, which are registered by a plurality of users on interne to dominantly manage his/her own personal health records by using the personal cloud repository 400 and the personal health record management device 200.

Then, a user authentication is performed on the personal health record management device 200 through the user authentication unit 210 in operation S120, and an authentication is performed on the registered user information and the personal cloud repository 400 to receive an access key from the cloud repository 400 and store it in the user-repository map DB 310 and a user authentication is performed on the personal cloud repository 400 in operation S120.

Then, if there is a storage request on the user's personal health records in operation S130, the user's personal health records are received from the user through the personal health record management device 200 in operation S160 and the received personal health records are stored in the personal cloud repository 400 of a corresponding user.

Moreover, the personal health records may be directly provided from the health record provider 500 providing the personal health records as well as a user.

Additionally, if there is a search request on the user's personal health records in operation S140, by searching for personal health records fit for a search condition through the personal health record management device 200, a found result is provided to the user in operation S141.

Moreover, description for the storage and search of the personal health records is made above and thus, their detailed description will be omitted.

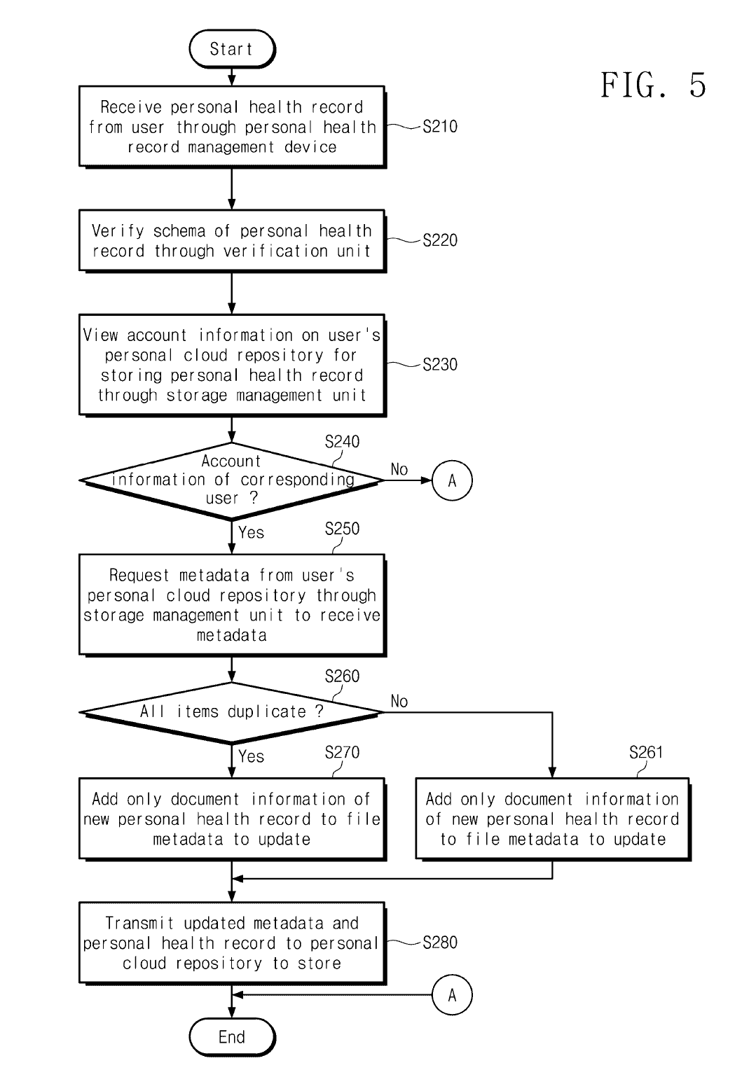

FIG. 5 is a flowchart illustrating a procedure for storing personal health records in a personal cloud repository according to an embodiment of the inventive concept.

As shown in FIG. 5, in order to store personal health records in the personal cloud repository 400, first, a user requests user's personal health records from the health record provider 500 and receives them in linkage with the healing platform 100 through his/her own terminal. At this point, it is apparent that the user is required to perform a user authentication on the health record provider 500.

Additionally, the user provides the received personal health records to the healing platform 100 and the personal health record management device 200 receives the user's personal health records from the healing platform 100 in operation S210.

Then, validity on the schema of the personal health records is verified through the verification unit 210 in operation S220.

Moreover, in order to divide the personal health records by a record unit and search for the personal health records, the personal health records are required to be divided by a record unit according to an accurate schema, and if the schema of the personal health records is not implemented properly or is defective or damaged, the verification is to prevent an issue that the personal health records are not divided by a record unit.

Moreover, although a procedure when the schema of the personal health records is not implemented properly or is defective or damaged based on a result obtained by verifying the schema of the personal health records is not shown in FIG. 5, if there is an issue based on the verification result, by notifying the user that a processing process such as searching for or storing corresponding personal health records cannot be performed, accurate personal health records are provided.

Then, account information on the personal cloud repository 400 of the user for storing the personal health records through the storage management unit 240 is viewed in operation S230.

Moreover, the storage management unit 240 views account information on the personal cloud repository 400 by referring to the user-repository map DB 310.

Then, if there are the account information and the access key of a corresponding user based on the view result in operation S240, by accessing the corresponding personal cloud repository 400, metadata for the personal health records of a corresponding user is requested from the corresponding personal cloud repository 400 and received in operation S250.

Moreover, when there is a request for the metadata, the personal cloud repository 400 accesses the metadata DB 410 to transmit metadata including file metadata and record metadata to the storage management unit 240.

Then, the storage management unit 240 reads the received file metadata to test whether there are duplicate items in the personal health record document and a document in operation S260 and if the ID of the personal health record document is duplicate, metadata is not updated and the document file is not stored also. If the document ID is not duplicate but all inside items (or records) are duplicate, as only document information of the personal health records is added to and update the file metadata, the file metadata is updated in operation S270.

Then, the updated file metadata and corresponding personal health records are transmitted to the personal cloud repository 400 and the personal cloud repository 400 stores the received file metadata and corresponding personal health records in operation S280.

Moreover, if all items are not duplicate based on the test result in operation S260, the storage management unit 240 adds new record information to the received record metadata and update it in operation S261, and transmits metadata and personal health records to the user's personal cloud repository 400 and store them in operation S280.

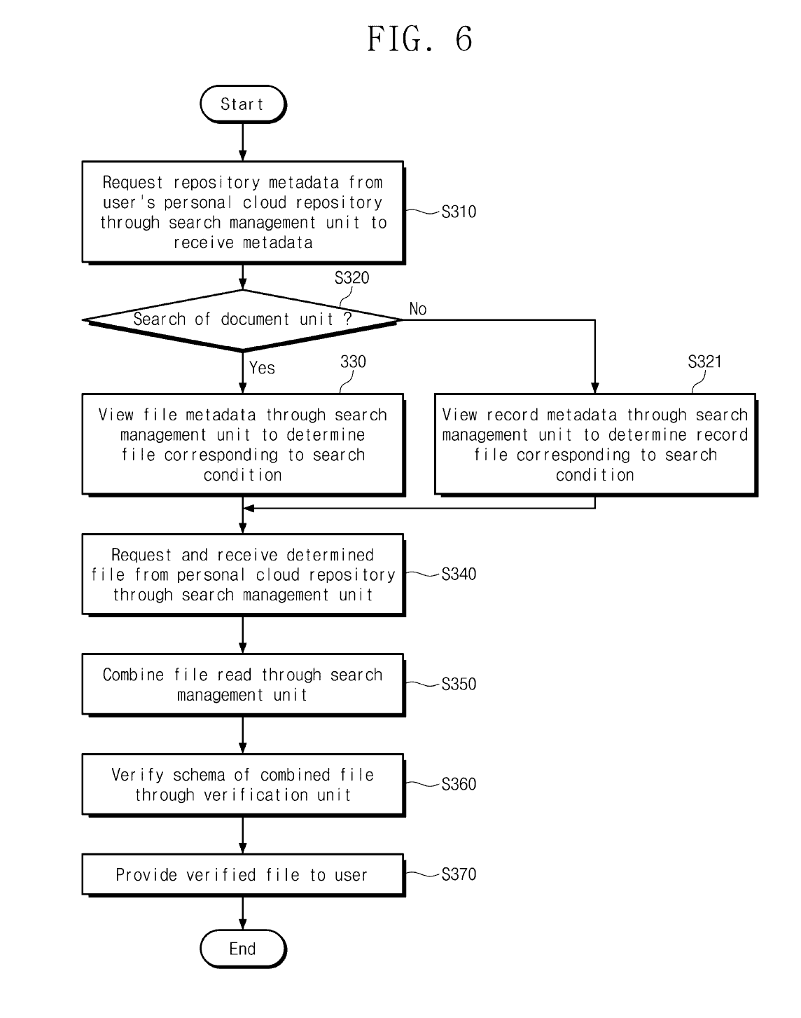

FIG. 6 is a flowchart illustrating a procedure for searching for personal health records from a personal cloud repository according to an embodiment of the inventive concept.

As shown in FIG. 6, like the procedure for performing search described with reference to FIG. 5, a procedure for searching for personal health records from a personal cloud repository receives a search request for personal health records from the user and views account information for the personal cloud repository of a corresponding user. Moreover, since the process for viewing account information is described in detail with reference to FIG. 5, although not shown in FIG. 6, it is apparent that search is performed through the process.

Furthermore, the search may be performed by a user or a request of the health service institution taking over an authority from a user.

Then, by accessing the personal cloud repository 400 of a corresponding user based on the viewed account information through the search management unit 250, metadata for user's personal health records is requested and received in operation S310.

Then, when a search condition requested by the user or the health service institution is a search of a document unit in operation S320, at least one document file corresponding to the search condition is determined by viewing file metadata through the search management unit 250 in operation S330, and the at least one document file is requested from the personal cloud repository 400 and received in operation S340.

Moreover, if the search condition is a search of a record unit, at least one record file corresponding to the search condition is determined by viewing record metadata in operation S321 and the at least one record file is requested from the personal cloud repository 400 and received in operation S340.

Then, by combining the received file through the search management unit 250, a schema of the combined file is verified through the verification unit 210 in operation S360 and as the verified file is transmitted to the healing platform 100 in operation S370, it is provided to the user or the health service institution.

Moreover, the user or the health service institution requests a specific data format for the search result, the personal health record management device 200 converts the combined file into the requested specific data format and verifies it to provide it to the user or the heath service institution.

Additionally, in order to search for the personal health records by each document or each record, the personal health record management device 100 generates metadata of the personal health records and the metadata will be described in more detail with reference to FIG. 7.

FIG. 7 is an exemplary view illustrating a configuration of metadata for referring to personal health records according to an embodiment of the inventive concept.

First, when storing the personal health records in the personal cloud repository 400, the personal health record management device 200 may divide an original unit single document file of the personal health records and a plurality of records configuring the personal health records into files of a record unit and store them, and according to the stored format, a configuration of metadata referring to the personal health records may be changed.

FIG. 7(A) represents a configuration of metadata when a single document file of an original unit of personal health records is stored.

Additionally, the metadata is stored in the user's personal cloud repository 400 and managed, and update for the metadata is performed by the personal health record management device 200.

Additionally, file metadata and record metadata shown in FIG. 7A are generated to refer to personal health records stored as the single document file.

Additionally, the file metadata is configured including a PhrType field, a DateTime field, a DocumentID field, and a Filename(loc) field. The PhrType field represents a type of a corresponding personal health record. The DateTime field represents a creation time of a corresponding document. The DocumentID field represents an ID for identifying the document. The Filename(loc) field represents information on a location where a file name and a corresponding file are stored.

Additionally, the record metadata is configured including a DateTime field, a RecordID field, a Filename(loc) field, and a LocationInFile field. The DateTime field represents a time at which a corresponding record is measured. The RecordID field represents a corresponding record. The Filename(loc) field represents information on a location where a corresponding document is stored. The LocationInFile field represents information on a location where a corresponding record is located in a corresponding document. The LocationInFile field is a field for referring to an item to be searched in a document file in order to correspond to an item unit search when an original is stored as only a document unit without storing as an item unit.

Additionally, the file metadata refers to a file of a single document unit, and maintains a stored document file, a record list of a document file, and location information of a document file. The record metadata refers to a record unit in a file stored as the document unit and maintains a stored document file, a record of a document file, and location information of a record.

Moreover, since the record metadata is stored by each PhrType field, an additional PhrType field is not required, and if record metadata is not distinctively stored by each health record type and is integrally stored as one file, a PhrType field may be additionally configured in the record metadata.

Additionally, file metadata and record metadata shown in FIG. 7B are generated to refer to personal health records stored as the record unit file.

Additionally, the file metadata is configured including a PhrType field, a DateTime field, a DocumentID field, a RecordID field, and a Filename(loc) field. The PhrType field represents a type of a corresponding personal health record. The DateTime field represents a creation time of a corresponding document. The DocumentID field represents an ID for identifying the document. The RecordID field represents an ID of a record configuring a document. The Filename(loc) field represents information on a location where a corresponding record file is stored.

Additionally, the record metadata is configured including a DateTime field, a RecordID field, and a Filename(loc) field. The DateTime field represents a time at which a corresponding record is measured. The RecordID field represents a corresponding record. The Filename(loc) field represents information on a location where a corresponding record file is stored. Herein, likewise, since the record metadata is stored by each PhrType field, an additional PhrType field is not required and may be additionally configured depending on an integration storage.

As the metadata is described above with reference to FIG. 7, by using the metadata, the personal health record management device 100 may search for each type of the personal health records (for example, treatment data, checkup data, or lifelog), and additionally may search for an item unit of each record type (for example, blood sugar, blood pressure, height, weight, or a combination thereof) included in the personal health records

Additionally, when the metadata is deleted, the personal health record management device 200 reads a directory structure from Root and re-generates metadata and when an original file of the personal health records is deleted, information on an original file mapping to the metadata is deleted to update the metadata.

Additionally, the personal health record management device 200 examines an inconsistency occurring between the metadata and the original file of the personal health records to update the metadata.

Moreover, the personal health record management device 100 may allow to view the personal health records by using only a specific application through the encryption of the personal health records, the encryption of metadata, and the access key and through this, may provide information on the user's personal health records.

Additionally, the personal health record management device 100 may maintain a record of a predetermined range (recent personal health record) in the user's terminal through record cashing and use it for search, and if there is no personal health record for a search condition after first performing a search in the terminal, allow to perform a search in the personal cloud repository 400, a search speed may be improved.

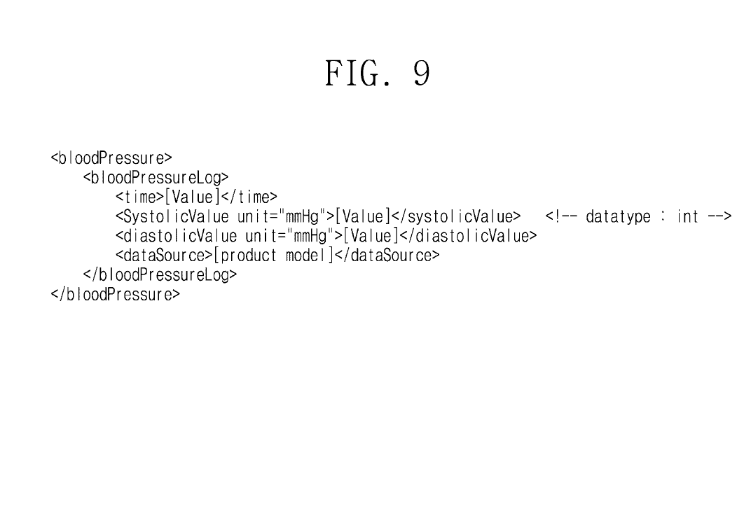

FIG. 8 is a view illustrating a CCR record item according to an embodiment of the inventive concept. FIG. 9 is a view illustrating a lifelog record item according to an embodiment of the inventive concept.

In more detail, FIG. 8 illustrates an example of a CCR record item that records information on a height, a measurement date at which a height is measured, and an actor (for example, an institution) in a CCR record item having a specific CCR data object ID and FIG. 9 is a view when blood pressure is measured and recorded by measuring blood pressure as a lifelog record item. Theses represent information corresponding to the record of FIG. 7 exemplarily

As described above, a personal cloud based personal health record management method and device according to the inventive concept may receive user's personal health records from a plurality of health service institutions through a single interface based on a personal health record management device in linkage with various health service institutions and integrally manage this efficiency.

The inventive concept relates to a personal cloud based personal health record management method and device. As a user dominantly manages his/her personal health records through a personal health record management device and a personal cloud repository, the inventive concept may have a complete management authority for user's personal health records. Based on personal health records including a variety of health information, various reliable health promotion services may be provided.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A personal cloud based personal health record management device comprising:
a metadata generation unit configured to receive a personal health record from at least one health record provider to generate metadata; and
a storage management unit configured store the received personal health record and the metadata in a personal cloud repository.

2. The device of claim 1, further comprising a verification unit configured to verify the received personal health record, wherein the personal cloud based personal health record management device generates metadata from the verified personal health record and stores the metadata in the personal cloud repository.

3. The device of claim 1, further comprising:
a verification unit configured to verify a personal health record provided from the at least one health record provider; and
a user authentication unit configured to perform a user's authentication on the personal health record management device and a user's authentication on the personal cloud repository.

4. The device of claim 1, wherein the storage management unit views account information on a user's personal cloud repository, updates and stores metadata on a corresponding account, and adds and stores a corresponding personal health record.

5. The device of claim 4, wherein the update is performed by reading file metadata and record metadata on the user's account, adding only new document information to the file metadata if both an item of the file metadata and a newly inputted item are duplicate, and adding only information on a new item to the record metadata if only a part is duplicate.

6. The device of claim 4, wherein the update is performed by reading file metadata and record metadata on the user's account and adding and storing the file metadata and the record metadata as a new document or a new item if a document ID is different.

7. The device of claim 1, further comprising a search management unit configured to search for and provide a personal health record by referring to metadata stored in the personal cloud repository according to a search condition inputted by a user.

8. The device of claim 7, wherein the search is performed as combining a search result according to a corresponding search condition by, if the search condition inputted by the user is a document search, viewing file metadata to determine at least one document file to be provided and by, if the search condition inputted by the user is a record search, viewing record metadata to determine at least one record file to be provided.

9. The device of claim 7, wherein the search management unit provides the found result to a user terminal after verifying a validity on each personal health record schema including treatment, checkup, or lifelog with respect to the found personal health record.

10. A personal cloud based personal health record management method comprising:
receiving a personal health record from at least one health record provider to generate metadata on the personal health record; and
storing the received personal health record and the metadata in a personal cloud repository.

11. The method of claim 10, further comprising verifying the received personal health record, wherein the method generates metadata from the verified personal health record and stores the metadata in the personal cloud repository.

12. The method of claim 10, further comprising performing a user's authentication on a personal health record management device and a user's authentication on the personal cloud repository.

13. The method of claim 10, wherein the storing of the received personal health record and the metadata comprises:
viewing account information on a user's personal cloud repository;
updating and storing metadata on a corresponding account; and
adding and storing a corresponding personal health record.

14. The method of claim 13, wherein the updating and storing of the metadata on the corresponding account comprises:
reading file metadata and record metadata on the user's account;
adding only new document information to the file metadata if both an item of the file metadata and a newly inputted item are duplicate; and
adding only information on a new item to the record metadata if only a part is duplicate.

15. The method of claim 13, wherein the updating and storing of the metadata on the corresponding account comprises:
reading file metadata and record metadata on the user's account; and
adding and storing the file metadata and the record metadata as a new document or a new item if a document ID is different.

16. The method of claim 10, further comprising searching for and providing a personal health record by referring to metadata stored in the personal cloud repository according to a search condition inputted by a user.

17. The method of claim 16, wherein the searching for the personal health record is performed as combining a search result according to a corresponding search condition by, if the search condition inputted by the user is a document search, viewing file metadata to determine at least one document file to be provided and by, if the search condition inputted by the user is a record search, viewing record metadata to determine at least one record file to be provided.

18. The method of claim 16, wherein the searching for the personal health record comprises providing the found result to a user terminal after verifying a validity on each personal health record schema including treatment, checkup, or lifelog with respect to the found personal health record.
